(19) United States
(12) Patent Application Publication
(10) Pub. No.: US 2007/0016522 A1
(43) Pub. Date: Jan. 18, 2007

(54) Data processing system for a billing address-based credit watch

(76) Inventor: Zhiping Wang, Arlington, VA (US)

Correspondence Address: Zhiping Wang, 5708 N. 11th Street, #10, Arlington, VA, 22205, US

(21) Appl. No.: 11/192,704

(22) Filed: Jul. 29, 2005

Related U.S. Application Data
(63) Continuation-in-part of application No. 11/182,923, filed on Jul. 15, 2005.

(51) Int. Cl. G06Q 40/00

(52) U.S. Cl. 705/40

(57) ABSTRACT

A data processing system for a billing address-based credit watch comprises a central controller with a CPU and a memory operatively connected to the CPU, and a plurality of creditors. The creditors periodically communicate with the central controller and transmit at least one consumer's payment information including the billing address to the central controller. The memory in the central controller contains a program for execution by the CPU for transferring the billing addresses transmitted from different creditors into a pre-defined common format and for combining the payment information from different creditors by matching billing addresses. Then the central controller transmits back to each creditor periodically the combined payment information including, for each billing address, at least one fraud flag when applicable to detect possible identity theft to provide the billing address-based credit watch.

### BACKGROUND OF THE INVENTION

This invention relates generally to the field of credit watch, credit monitoring, credit analysis and more specifically to a data processing system for a billing address-based credit watch.

The advent of modern technology has made people's life much easier. More and more people use credit cards to make purchases. The convenience is obvious; consumers do not need to carry cash with them. Now with the help of the Internet, consumers can proceed with shopping even without traveling to merchant stores.

With the modern technology for credit checking, consumers can do a lot of things. They can easily open bank accounts, open credit-card accounts, obtain cell phone services, buy motor vehicles and take out car loans, apply for student loans, buy houses and take out mortgages, start utilities services, etc. The consumers do not even need to be physically present to finish most of these tasks.

Simply put, credit is just borrowed money; consumers do not need to have money at the time of purchase. But consumers are required to pay back these “loans” at a later time.

However, this also accounts for America's number one consumer complaint at the Federal Trade Commission, identity theft. The July 2005 issue of “Money” reported that about 9.3 million Americans have been victims by identity theft. As reported by NBC, some people's identities are even on sale on the Internet. Identity theft is a fast growing crime in America and it is being reported that billions of dollars have been lost because of identity theft. It is a big problem for consumers, creditors and insurers, especially for creditors and insurers since they are required to absorb nearly all of the losses.

Right now there are several ways to fight against identity thefts. First, consumers can watch their credit reports. Consumers can get a free report once a year. Second, consumers can freeze their credit. Third, consumers can purchase identity theft insurance. Fourth, consumers can establish credit monitoring services with some companies so that the consumers can be notified if a fraud is occurring.

However, these methods all have their limitations and disadvantages. Free credit reports are only available to consumers once a year and consumers may not get the credit reports in time to catch a fraud. Credit freeze is not available in most areas in America, and in some areas only the victims of identity thefts can freeze their credit. Too little, too late. Public awareness of identity theft insurance is low and most consumers are reluctant to pay for identity theft insurance. Public awareness of credit monitoring services is similarly low and many consumers may not be willing to pay for such services.

In general when a thief steals other people's identities to open bank accounts, apply for loans, or open credit-card accounts, etc., the thief does not intend to pay off the loans or credit-card balances and the thief will use a billing address other than the victim's. This reality gives an important clue for catching identity theft and is utilized by the present invention to detect identity theft at early stages in order to prevent or at least mitigate further financial losses and damage to the consumer's reputation.

### BRIEF SUMMARY OF THE INVENTION

The primary object of the invention is to provide a data processing system containing means for a billing address-based credit watch.

Another object of the invention is to provide a system and method which will allow each creditor to recognize a consumer's broader, even complete, payment information based on the billing address.

Another object of the invention is to provide each creditor with a method to detect addresses where identity thefts might be occurring, hence to reduce, at least to mitigate, further financial losses and damage to a consumer's reputation.

A further object of the invention is to provide each creditor with a method to identify addresses where consumers may need financial help.

Yet another object of the invention is to provide each creditor with a method to identify addresses for direct marketing to consumers in good financial condition.

Other objects and advantages of the present invention will become apparent from the following descriptions, taken in connection with the accompanying drawings, wherein, by way of illustration and example, embodiments of the present invention are disclosed.

In accordance with one embodiment of the invention, there is disclosed a data processing system for a billing address-based credit watch comprising: a central controller including a CPU and a memory operatively connected to the CPU, and a plurality of creditors. Each of these creditors respectively communicates with the central controller and transmits at least one billing address and payment information associated with the billing address to the central controller periodically. The memory in the central controller contains a program for execution by the CPU for transferring all billing addresses transmitted from each of these creditors into a pre-defined common format and for combining the payment information from different creditors by matching the billing address(es). Then the central controller periodically transmits back to each of these creditors the combined payment information including, for each billing address, at least one fraud flag when applicable to detect possible identity theft and provide the billing address-based credit watch.

In accordance with another embodiment of the invention, there is disclosed a data processing system for a billing address-based credit monitoring comprising: a central controller including a CPU and a memory operatively connected to the CPU, and a plurality of creditors. These creditors respectively communicate with the central controller and transmit at least one billing address and payment information associated with the billing address to the central controller monthly. The memory in the central controller contains a program for execution by the CPU for transferring all billing addresses transmitted from each of these creditors into a pre-defined common format and for combining the payment information from each of these creditors by matching the billing addresses. Then the central controller transmits back to each of these creditors monthly the combined payment information including, for each billing address, at least one payment flag (P-flag) to identity the address where consumers may need financial help.

In accordance with yet another embodiment of the invention, there is disclosed a data processing system for a billing address-based credit watch comprising: a central controller including a CPU, a memory and a central database operatively connected to the CPU, and a plurality of creditors. These creditors respectively communicate with the central controller and transmit at least one billing address and payment information associated with the billing address to the central controller periodically. The memory in the central controller contains a program for execution by the CPU for transferring all billing addresses transmitted from different creditors into a pre-defined common format and for combining the payment information by matching the billing address(es). Then the central database stores the combined payment information and the central controller updates the central database once the memory gets new combined payment information to keep the central database current. The creditors remotely access the central database anytime to get the combined payment information for using the billing address-based credit watch.

### BRIEF DESCRIPTION OF THE DRAWINGS

The drawings constitute a part of this specification and include exemplary embodiments of the invention which may be embodied in various forms. It is to be understood that in some instances various aspects of the invention may be shown exaggerated or enlarged to facilitate an understanding of the invention.

FIG. 1 is a flow chart of a billing address-based credit watch operation according to the invention that comprises a Central Controller and a plurality of creditors.

FIG. 2 is a flow chart illustrating an example according to the invention combining the payment information transmitted from Creditor 20 and Creditor 21 by Central Controller 30.

### DETAILED DESCRIPTION OF THE PREFERRED EMBODIMENTS

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In accordance with the present invention, a billing address-based credit watch system provides a gateway for creditors to detect identity thefts at early stages, hence further financial losses can be reduced, or at least mitigated. With more detailed consumer payment information transmitted, the data processing system for the billing address-based credit watch can provide creditors broader, even complete, payment information about respective consumers residing at a particular billing address so that not only identity thefts can be detected, but also the billing address where consumers need financial help may be identified. Advantageously, the inventive credit watch system does not require private information regarding particular consumers, only billing addresses, so that the most sensitive consumer information is protected.

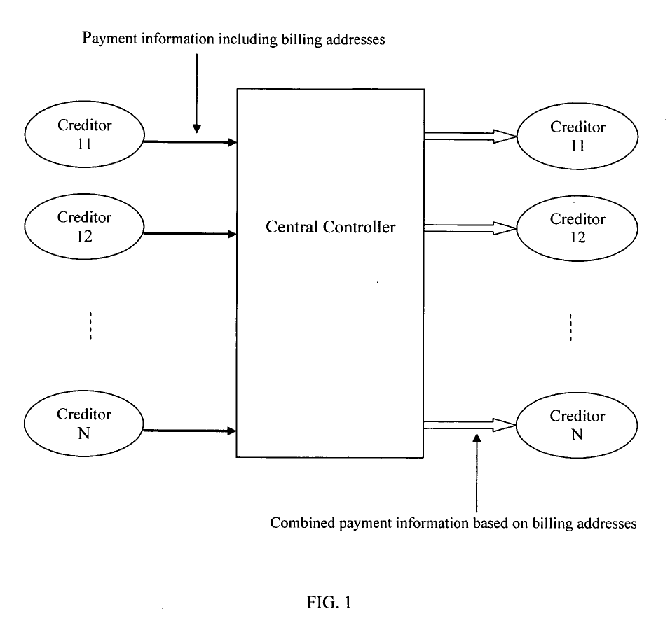

Turning first to FIG. 1, shown are a central controller and a plurality of creditors.

Creditors comprise lenders including banks, credit card issuers, mortgage issuers, and car loan issuers and merchants who let consumers make purchases first for subsequent payment(s) at a time in the future after delivery.

The creditors communicate with the central controller by respectively transmitting at least one consumer's payment information including the billing address to the central controller periodically, typically monthly, more preferably as payments for the billing address become past due and/or are made to provide the most current information.

The central controller includes a CPU and a memory operatively connected to the CPU. The CPU reads the consumer's payment information transmitted from each of these creditors into the memory.

The program in the memory is executed to transfer all addresses into a pre-defined common format, so that the billing addresses from different creditors are comparable and can be matched. For example, the format may use STREET instead of Street, St, ST; ROAD, instead of Road, Rd, RD; DRIVE, instead of Drive, Dr, DR; the symbol, #, instead of NUMBER, Number, NO., No., Num, NUM, etc.

Then, the program in the memory is executed to combine the payment information transmitted from different creditors by matching the billing address(es).

For any billing address, when the number of accounts not been paid at all compared with the previous period is increasing, a fraud flag will be turned on, i.e., changed from N to Y, i.e., from “no, N” to “yes, Y”. If the number of accounts not been paid at all is decreasing, the fraud flag will be turned off, i.e., changed from Y to N, i.e., from “yes, Y” to “no, N”.

Finally, the combined payment information is sent back to each creditor at the same periodic basis as the payment information transmitted by respective creditors, typically monthly, but advantageously as payments come due and/or are made.

The payment information transmitted by each of these creditors comprises, for each active account, billing address and an indicator for whether an amount due has not been paid at all when due.

The payment information transmitted by each of these creditors comprises the billing addresses and payment information of active accounts opened with respective creditors, where active accounts are the accounts with balances greater than 0 in the present period and these balances could be paid in full, or be partially paid, or not be paid at all when due.

Furthermore the payment information transmitted and the combined payment information transmitted from and to each of these creditors comprise the billing addresses in areas served by respective creditor.

The payment information transmitted by each of these creditors preferably comprises, for each active account, an indicator for whether the amount due has been partially paid when due.

The payment information transmitted by each of these creditors preferably further comprises, for each active account, an indicator for whether the amount due has been fully paid when due.

The payment information transmitted by each of these creditors preferably further comprises, for each account, its amount due and amount paid when due.

In the combined payment information transmitted from the central controller, if a billing address has an account not being paid at all when due, any creditor not yet serving this billing address is thus warned to be careful about loan applications, credit card applications or any other application from this address, regardless of who the applicant claims to be. This flag signifies where an identity theft might be occurring, especially when the number of accounts not being paid at all when due for this billing address is increasing or is a big number already, for example, a number greater than 2. Thus, identity theft might be detected at an earlier stage and further financial losses or damage to a consumer's reputation could be reduced, or at least mitigated. The creditors serving this address may need to take some action accordingly. The creditors may also need to check other sources before a decision is made to be certain about the identity of the applicant.

When a billing address in the combined payment information transmitted from the central controller has several accounts being just partially paid, it is with high possibility that the consumers at this address may need some financial help. The creditors not yet serving this address would be well advised to be careful about loan applications, credit card applications or any other application from this address. To prevent the financial situation from getting worse, the creditors already serving this billing address may need to find ways to help the consumers at this billing address.

Compared with the previous period for a billing address, when the number of accounts being partially paid when due is increasing, a payment flag (P-flag), will be turned on, i.e., changed from N to Y, i.e., from “no, N” to “yes, Y”. Conversely, if the number of accounts being partially paid when due is decreasing, the payment flag will be turned off, i.e., changed from Y to N, i.e., from “yes, Y” to “no, N”.

If a billing address shown in the combined consumer's payment information transmitted from the central controller has paid in full all amounts due, i.e., the sum of amounts paid when due is greater than 0 and at least equal to the sum of amounts due, the consumers at this billing address are in good financial standing and creditors and merchants would be well advised and encouraged to do business with the consumers at this billing address. For this billing address, this is also the case when the number of accounts being fully paid when due is greater than 0 and both the number of accounts not being paid at all when due and the number of accounts being partially paid when due are equal to 0.

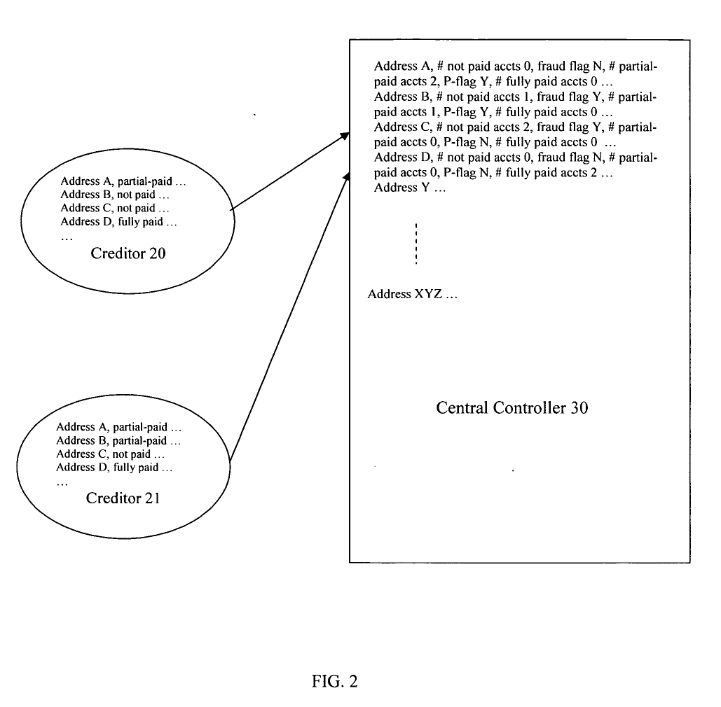

Turning now to FIG. 2, shown is a block diagram illustrating an exemplary system according to the invention for combining payment information transmitted from Creditor 20 and Creditor 21 by the program in the memory of the CPU inside of Central Controller 30.

As shown in FIG. 2, for Creditor 20, Address A has one account partially paid when due, Address B has one account not paid at all when due, Address C has one account not paid at all when due, and Address D has one account with full payment made when due, etc.; for Creditor 21, both Addresses A and B have one account partially paid when due, Address C has one account not paid at all when due, and Address D has one account with full payment made when due, etc.

In FIG. 2 again, after the program at the memory in Central Controller 30 is executed to combine the payment information transmitted from Creditor 20 and Creditor 21, in the combined payment information, Address A has 0 number of not-paid accounts, 2 partial-paid accounts and 0 number of accounts with full payment made when due; Address B has 1 not-paid account, 1 partial-paid account and 0 number of accounts with full payment made when due; Address C has 2 not-paid accounts, 0 number of partial-paid accounts and 0 number of accounts with full payment made when due, Address D has 2 accounts with full payment maid when due, 0 number of not-paid accounts and 0 number of partial-paid accounts, etc. Since compared with the previous period, the number of partial-paid accounts is increased for Addresses A and B, the payment flag (P-flag) is turned on, that is, changed to Y for both Addresses A and B. Similarly since the number of not-paid accounts is increased compared with the previous period for both Addresses B and C, the fraud flag is turned on, i.e., Y, for both Addresses B and C.

When the preferable amount due and amount paid when due for each account are included in the payment information transmitted by the creditors, for the same billing address, these amounts due and amounts paid when due are added up respectively to get the sum of amounts due and the sum of amounts paid when due after the program in the memory of CPU is executed to combine the payment information. By comparing the amount due and amount paid in the payment information transmitted from respective creditors, it is very easy to find out the number of not-paid accounts, the number of partial-paid accounts and the number of fully-paid accounts for each billing address. Therefore, the creditors may have broader, even complete payment information about the consumers at this billing address. Thus, the addresses where identity thefts might be occurring can be detected at earlier stages so that further financial losses and damage to a consumer's reputation can be reduced, or at least mitigated.

The combined payment information is stored in a central database in the central controller. The central database is updated after a creditor transmits payment information to the central controller so that the central database is maintained current. Creditors may be permitted to access the central database remotely through the Internet or any other network. They are encouraged to do so as often as they need to, especially when they need to check the combined payment information for a particular billing address. The creditors can access the central database using one billing address or part of an address, for example, using just the zip code, to get the combined payment information for a particular billing address or related billing addresses.

While the invention has been described in connection with preferred embodiments, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A data processing system for a billing address-based credit watch, comprising:
a central controller including a CPU and a memory operatively connected to the CPU;
a plurality of creditors, who respectively communicate with said central controller and transmit at least one billing address and payment information associated with respective ones of said at least one billing address to said central controller periodically,
wherein the memory in the central controller contains a program for execution by said CPU for transferring said at least one billing address transmitted from respective ones of said plurality of creditors into a pre-defined common format and for combining said payment information associated with respective ones of said at least one billing address transmitted by respective ones of said plurality of creditors by matching payment information with respective ones of said at least one billing address to provide combined payment information for each respective at least one billing address, and
wherein said central controller periodically transmits back to each of said plurality of creditors said combined payment information including, for each of said at least one billing address, at least one fraud flag when applicable to detect possible identity theft and provide said billing address-based credit watch.

2. The data processing system for a billing address-based credit watch as claimed in claim 1, wherein said plurality of creditors comprise lenders including banks, credit-card issuers, mortgage issuers, and automobile loan issuers, and merchants who let consumers make purchases first for subsequent payment at a time in the future after delivery.

3. The data processing system for a billing address-based credit watch as claimed in claim 1, wherein said payment information associated with respective ones of said at least one billing address transmitted by said plurality of creditors comprises at least one billing address and payment information associated with said at least one billing address for active accounts opened with respective ones of said plurality of creditors.

4. The data processing system for a billing address-based credit watch as claimed in claim 1, wherein said payment information and said combined payment information transmitted from and to respective ones of said plurality of creditors further comprise the billing addresses in areas served by respective ones of said plurality of creditors.

5. The data processing system for a billing address-based credit watch as claimed in claim 1, wherein said payment information associated with respective ones of said at least one billing address transmitted by said plurality of creditors further comprises, for each active account, the billing address, payment information and an indicator for whether an amount due has not been paid at all when due.

6. The data processing system for a billing address-based credit watch as claimed in claim 1, wherein said payment information associated with respective ones of said at least one billing address transmitted by said plurality of creditors further comprises, for each active account, an indicator for whether an amount due has been partially paid when due.

7. The data processing system for a billing address-based credit watch as claimed in claim 1, wherein said payment information associated with respective ones of said at least one billing address transmitted by said plurality of creditors further comprises, for each active account, an indicator for whether an amount due has been fully paid when due.

8. The data processing system for a billing address-based credit watch as claimed in claim 1, wherein said payment information associated with respective ones of said at least one billing address transmitted by said plurality of creditors further comprises, for each account, amount due and amount paid when due.

9. The data processing system for a billing address-based credit watch as claimed in claim 1, wherein said combined payment information transmitted from said central controller comprises, for each of said at least billing address, a sum of amounts due and a sum of amounts paid when due to said plurality of creditors.

10. The data processing system for a billing address-based credit watch as claimed in claim 1, wherein said combined payment information transmitted from said central controller further comprises, for each of said at least one billing address, the billing address, number of accounts not being paid at all when due, number of accounts with partial payment made when due, number of accounts with full payment made when due, a sum of amounts due and a sum of amounts paid when due, a fraud flag when applicable indicating whether the number of accounts not being paid at all when due is increasing and a payment flag (P-flag) when applicable indicating whether the number of accounts with partial payment made when due is increasing, so that identity thefts may be detected at earlier stages and further financial losses and damage to consumer's reputation can be mitigated, so that the billing addresses where consumers may need financial help may be identified, and so that the billing addresses with full payment may be identified.

11. A data processing system for a billing address-based credit monitoring, comprising:
a central controller including a CPU and a memory operatively connected to the CPU;
a plurality of creditors who respectively communicate with said central controller and transmit at least one billing address and payment information associated with respective ones of said at least one billing address to said central controller monthly,
wherein the memory in the central controller contains a program for execution by said CPU for transferring said at least one billing address transmitted from respective ones of said plurality of creditors into a pre-defined common format and for combining said payment information associated with respective ones of said at least one billing address transmitted from respective ones of said plurality of creditors by matching payment information with respective ones of said at least one billing address to provide combined payment information for each respective at least one billing address, and
wherein said central controller transmits back to each of said plurality of creditors monthly said combined payment information including, for each of said at least one billing address, at least one payment flag (P-flag) when applicable to identity the address where consumers may need financial help to provide said billing address-based credit monitoring.

12. The data processing system for a billing address-based credit monitoring as claimed in claim 11, wherein said plurality of creditors comprise lenders including banks, credit-card issuers, mortgage issuers, and automobile loan issuers, and merchants who let consumers make purchases first for subsequent payment at a time in the future after delivery.

13. The data processing system for a billing address-based credit monitoring as claimed in claim 11, wherein said payment information and said combined payment information transmitted from and to respective ones of said plurality of creditors comprise the billing addresses in areas served by respective ones of said plurality of creditors.

14. The data processing system for a billing address-based credit monitoring as claimed in claim 11, wherein said payment information associated with respective ones of said at least one billing address transmitted by said plurality of creditors further comprises at least one billing address and payment information associated with said at least one billing address for active accounts opened with respective ones of said plurality of creditors.

15. The data processing system for a billing address-based credit monitoring as claimed in claim 11, wherein said payment information associated with respective ones of said at least one billing address transmitted by said plurality of creditors further comprises, for each active account, the billing address, payment information and an indicator for whether an amount due has been partially paid when due.

16. The data processing system for a billing address-based credit monitoring as claimed in claim 11, wherein said payment information associated with respective ones of said at least one billing address transmitted by said plurality of creditors further comprises, for each active account, an indicator for whether an amount due has not been paid at all when due.

17. The data processing system for a billing address-based credit monitoring as claimed in claim 11, wherein said payment information associated with respective ones of said at least one billing address transmitted by said plurality of creditors further comprises, for each active account, an indicator for whether an amount due has been fully paid when due.

18. The data processing system for a billing address-based credit monitoring as claimed in claim 11, wherein said payment information associated with respective ones of said at least one billing address transmitted by said plurality of creditors further comprises, for each account, amount due and amount paid when due.

19. The data processing system for a billing address-based credit monitoring as claimed in claim 11, said combined payment information transmitted from said central controller comprises, for each of said at least billing address, a sum of amounts due and a sum of amounts paid when due to said plurality of creditors.

20. The data processing system for a billing address-based credit monitoring as claimed in claim 11, wherein said combined payment information transmitted from said central controller further comprises, for each of said at least one billing address, the billing address, number of accounts not being paid at all when due, number of accounts with partial payment made when due, number of accounts with full payment made when due, a sum of amounts due and a sum of amounts paid when due, a fraud flag when applicable indicating whether the number of accounts not being paid at all when due is increasing and a payment flag (P-flag) when applicable indicating whether the number of accounts with partial payment made when due is increasing, so that identity thefts may be detected earlier and further financial losses and damage to consumer's reputation can be mitigated, so that the billing addresses where consumers may need financial help may be identified, and so that the billing addresses with full payment may be identified.

21. A data processing system for a billing address-based credit watch, comprising:
a central controller including a CPU, a memory and a central database operatively connected to the CPU;
a plurality of creditors, who respectively communicate with said central controller and transmit at least one billing address and payment information associated with respective ones of said at least one billing address to said central controller periodically,
wherein the memory in the central controller contains a program for execution by said CPU for transferring said at least one billing address transmitted from respective ones of said plurality of creditors into a pre-defined common format and for combining said payment information associated with respective ones of said at least one billing address transmitted by respective ones of said plurality of creditors by matching payment information with respective ones of said at least one billing address to provide combined payment information for each respective at least one billing address, and
wherein said central database stores said combined payment information and said central controller updates said central database once said memory gets new combined payment information to keep said central database current, and
wherein said plurality of creditors remotely access said central database anytime to get said combined payment information for using said billing address-based credit watch.

22. The data processing system for a billing address-based credit watch as claimed in claim 21, wherein said plurality of creditors comprise lenders including banks, credit-card issuers, mortgage issuers, and automobile loan issuers, and merchants who let consumers make purchases first for subsequent payment at a time in the future after delivery.

23. The data processing system for a billing address-based credit watch as claimed in claim 21, wherein said payment information associated with respective ones of said at least one billing address transmitted by said plurality of creditors comprises at least one billing address and payment information associated with said at least one billing address for active accounts opened with respective ones of said plurality of creditors.

24. The data processing system for a billing address-based credit watch as claimed in claim 21, wherein said payment information associated with respective ones of said at least one billing address transmitted by said plurality of creditors further comprises, for each active account, the billing address, payment information and an indicator for whether an amount due has not been paid at all when due.

25. The data processing system for a billing address-based credit watch as claimed in claim 21, wherein said payment information associated with respective ones of said at least one billing address transmitted by said plurality of creditors further comprises, for each active account, an indicator for whether an amount due has been partially paid when due.

26. The data processing system for a billing address-based credit watch as claimed in claim 21, wherein said payment information associated with respective ones of said at least one billing address transmitted by said plurality of creditors further comprises, for each active account, an indicator for whether an amount due has been fully paid when due.

27. The data processing system for a billing address-based credit watch as claimed in claim 21, wherein said payment information associated with respective ones of said at least one billing address transmitted by said plurality of creditors further comprises, for each account, amount due and amount paid when due.

28. The data processing system for a billing address-based credit watch as claimed in claim 21, wherein said combined payment information transmitted from said central controller comprises, for each of said at least billing address, a sum of amounts due and a sum of amounts paid when due to said plurality of creditors.

29. The data processing system for a billing address-based credit watch as claimed in claim 21, wherein said combined payment information stored in said central database comprises, for each of said at least one billing address, the billing address, number of accounts not being paid at all when due, number of accounts with partial payment made when due, number of accounts with full payment made when due, a sum of amounts due and a sum of amounts paid when due, a fraud flag when applicable indicating whether the number of accounts not being paid at all when due is increasing and a payment flag (P-flag) when applicable indicating whether the number of accounts with partial payment made when due is increasing, so that identity thefts may be detected at earlier stages and further financial losses and damage to consumer's reputation can be mitigated, so that the billing addresses where consumers may need financial help may be identified, and so that the billing addresses with full payment may be identified.
